(19) United States
(12) Patent Application Publication
(10) Pub. No.: US 2010/0043174 A1
(43) Pub. Date: Feb. 25, 2010

(54) HINGE CONSTRUCTION

(75) Inventors: Nikolaj Bestle, Copenhagen (DK); Herman Scherling, Kokkedal (DK)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/519,330

(22) PCT Filed: Dec. 18, 2006
(86) PCT No.: PCT/EP06/12172

§ 371 Date: Jun. 15, 2009

(51) Int. Cl. E05F 1/12; E05D 5/02; E05D 5/14

(52) U.S. Cl. 16/303; 16/388; 16/386

(57) ABSTRACT

A hinge construction for a mobile apparatus that includes two hingedly connected to body parts includes an actuator assembly that is located in one of the body parts and a connection rod that transmits the torque generated by the actuator assembly to the other body part.

### FIELD OF THE INVENTION

The present invention relates to a hinge construction for a folding device.

### BACKGROUND OF THE INVENTION

Mobile devices, such as mobile phones with a body that includes two hingedly connected body parts are well-known. Typically, the body parts can fold together in a closed position and be unfolded to an open position. In the recent past there has been a trend towards thinner mobile phones. A typically bi-stable spring mechanism urges the body parts towards the closed position when the angle between the body parts is relatively sharp, and urges the body parts towards the open position when the angle between the body parts is relatively obtuse. Normally, the bi-stable spring mechanism is integrated in the hinge, with a compression spring attached with one end to one of the two body parts and a stationary part of a cam mechanism attached to the other end of the spring. The non-stationary part of the cam mechanism is attached to the other of the two body parts, and depending on the relative rotational position between the parts of the cam mechanism the compression spring is compressed to various degrees. The torque to angle profile (of the torque applied by the cam mechanism to the body parts) depends on the shape of the complementary parts of the cam mechanism. The diameter of the hinge including the bi-stable spring mechanism has become a limiting factor for further reducing the thickness of fold phones.

### DISCLOSURE OF THE INVENTION

On this background, it is an object of the present invention to provide a hinge construction that enables the construction of thinner mobile apparatuses. This object is achieved by providing a hinge construction for a folding apparatus body, comprising a first body part connected to a second body part by a hinge that has a hinge axis, an actuator assembly disposed in said first body part or in said second body part, a link rod operably connected to said actuator, said link rod comprises a substantially first portion and a peg at an angle with said first portion, said peg being connected to said first portion by an elbow portion that substantially coincides with said hinge axis, said first portion is rotatably suspended in said first body part, and said peg is received in a slot in said second body part.

By placing the actuator assembly outside the hinge the diameter of the hinge can be substantially reduced and thereby the construction of thin fold type mobile apparatuses is facilitated.

Preferably, one end of the first portion is connected to the actuator assembly in the first body portion. Alternatively, the peg is connected to the actuator assembly in the second body portion.

The actuator assembly may comprise a cam mechanism that translates a rotating movement into a linear movement.

The hinge may comprise a tubular element and a hinge pin. The connection elbow of the connection rod may have a diameter that is substantially as large as the outer diameter of the tubular element so that the connection rod can handle high torque.

The first portion may include a section with an increased diameter for transmitting axial forces applied to the first portion to the first body part.

The connecting rod may include a second peg at an angle to the first portion, the second peg being received in a slot formed in the actuator assembly.

The actuator assembly may include a compression spring or an extension spring.

The first portion can be placed at an acute angle with the hinge axis.

The actuator assembly can be configured to define a stable closed position and a stable open position.

Further objects, features, advantages and properties of the hinge construction according to the invention will become apparent from the detailed description.

### BRIEF DESCRIPTION OF THE DRAWINGS

In the following detailed portion of the present description, the invention will be explained in more detail with reference to the exemplary embodiments shown in the drawings, in which:

FIG. 1 is an elevated view of a mobile apparatus with the hinge construction according to an embodiment of the invention in an open position,

FIG. 2 is the mobile apparatus of FIG. 1 in a closed position,

FIG. 3 is a semi-transparent bottom view of the mobile apparatus of FIG. 1 in a closed position

FIG. 4 is a semi-transparent side view in detail of the mobile apparatus of FIG. 1 in a closed position,

FIG. 5 is a semi-transparent side view in detail of the mobile apparatus of FIG. 1 in an intermediate position,

FIG. 6 is a semi-transparent side view in detail of the mobile apparatus of FIG. 1 in an open position,

FIG. 7 is an elevated view in detail of a connection rod that is used in an embodiment of the hinge connection according to the invention,

FIG. 8 is a worked open view on the hinge construction according to an embodiment of the invention, and

FIG. 9 is a semi-transparent bottom view of another embodiment of the hinge construction according to the invention.

### DETAILED DESCRIPTION OF PREFERRED EMBODIMENTS

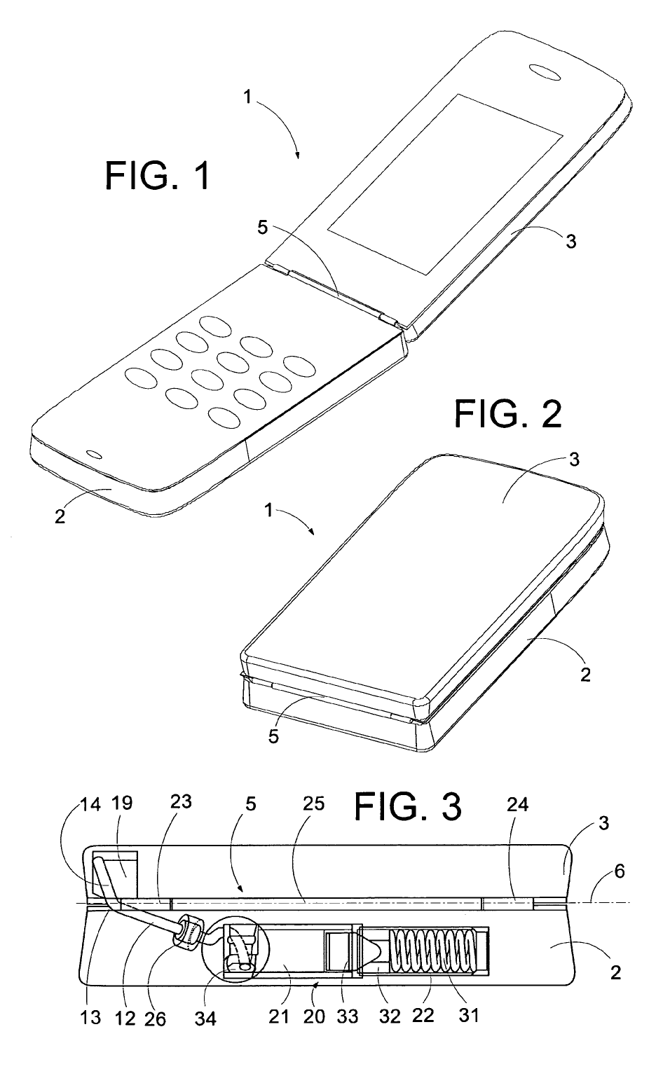

As shown in FIG. 1, a folding mobile phone 1 provided with a hinge 5 has a hinge construction according to an embodiment of the invention. The body of the mobile phone 1 includes two parts 2 and 3 hingedly connected together. One body part 3 includes an ear speaker and a display. The other body part 2 includes a keypad and the microphone. Body parts 2 and 3 are of approximately the same dimensions, so that the length of the phone body is roughly halved by folding it into a closed position as shown in FIG. 2. According to an embodiment, (not shown) one of the body parts may be substantially thicker than the other of the body parts.

As shown in further detail in FIG. 3, body parts 2 and 3 are connected by a hinge 5, which includes tubular portions 23,24 integrally formed or secured to body part 3 and tubular portion 25 integrally formed or secured to body part 2. The portions 23, 24 and 25 of a hinge 5 are aligned with one another and define a passageway extending from one axial end of hinge 5 to the other. The passageway coincides with the hinge axis 6. Mounted in this passageway is a hinge pin 7. The hinge pin 7 is secured not to disengage the passage way in any well known manner.

An actuator assembly 20 is located in body part 2, preferably near the hinge 5. The longitudinal axis of the elongated actuator assembly 20 is in this embodiment placed parallel with the hinge axis 6. However, the longitudinal axis of the actuator assembly 20 may also be placed at an angle with the hinge axis 6. The actuator assembly 20 includes a static portion 22 that is secured to the body part 2 and a rotatable portion 21 that can rotate freely with respect to the static portion 22 and with respect to the body part 2. The static portion 22 includes a compression spring 31 and a first portion of a cam mechanism 32. The first portion of the cam mechanism 32 is slidably received inside the static portion 22 of the actuator 20. The compression spring 31 urges the first portion 32 of the cam mechanism towards a second portion 33 of the cam mechanism. The second portion 33 of the cam mechanism is connected to the rotatable portion 21 and the moves in unison there with. The first portion 32 and the second portion 33 of the cam mechanism have a complementary shape. This complementary shape is chosen in accordance with circumstances to achieve the required torque to angle relationship of the actuator assembly 20.

According to an embodiment, the actuator assembly 20 has a torque to angle relationship that results in a bi-stable hinge construction with the actuator 20 urging the body parts 2 and 3 in the closing direction when the body parts 2 and 30 are positioned at an angle between an intermediate angle and the closed position whilst the actuator 20 urges the body parts 2 and 3 in the opening direction when the body parts 2 and 3 are positioned at an angle between an intermediate angle and the open position.

According to an embodiment, the intermediate angle is roughly in the middle between the open position and the closed position, but according to circumstances and requirements this angle could be away from the middle or center position.

According to an embodiment it is also possible that the actuator to angle profile is not bi-stable, but simply urges the body parts 2 and 3 away from one another at relative angular positions of the body parts 2 and 3. In such an embodiment of the actuator assembly 20 can be formed by a torsion spring and does not include any cam mechanism. Further, the mobile apparatus 1 will be provided with a latch mechanism, locking the body parts 2 and 3 in the closed position until the locking mechanism is released by a user.

Any other profiles as desired by the designer of the mobile phone 1 can be applied by selecting the appropriate shapes for the compliment very parts of the cam mechanism.

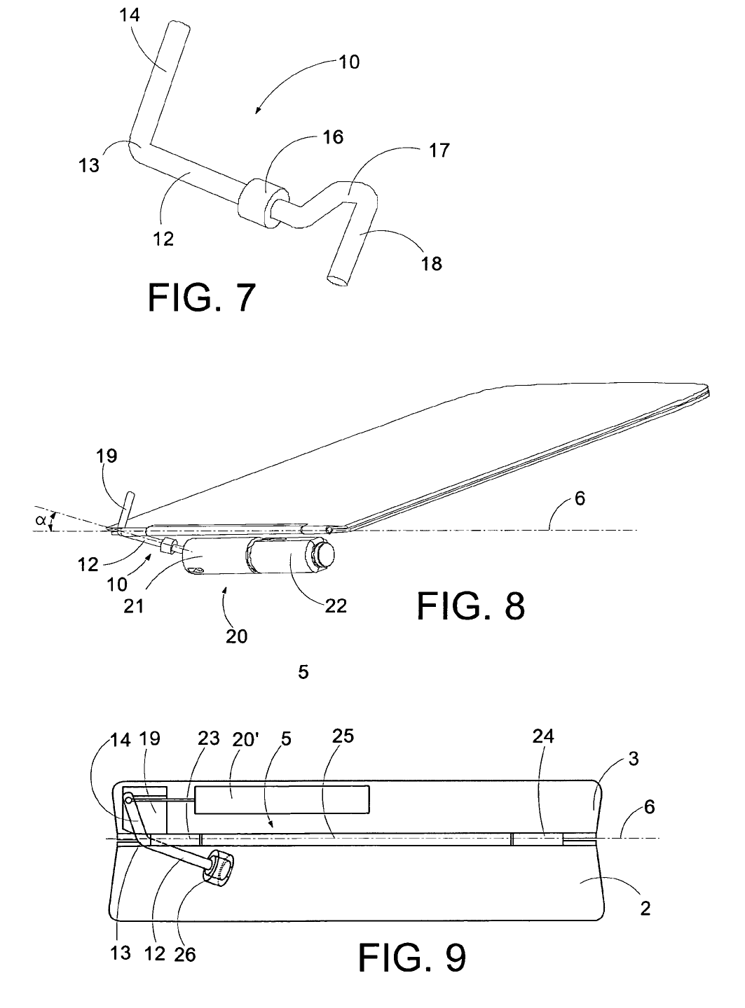

A connecting rod 10 (as shown in greater detail in FIG. 7) connects to the rotatable portion 21 of the actuator assembly 20 with body part 2. The connecting rod 10 includes a straight portion 12 that is rotably suspended in body part 2 at an acute angle α with the hinge axis 6. The straight portion 12 includes an enlarged diameter section 16 (FIG. 7) that is received in a corresponding recess 26 in the body part 2. The side walls of the enlarged diameter section 16 provide bearing surfaces collaborating with corresponding surfaces in the body part 2 in order to handle axial forces that are applied to the connecting rod 10. According to another embodiment, a reduced diameter section (not shown) in the straight portion 12 collaborates with protrusions (not shown) in body part 2.

The connecting rod also includes a peg 14 that is connected at an angle to the straight portion 12 by an elbow 13. The elbow 13 falls substantially together with the hinge axis 6. The angle between the peg 14 and the straight portion 12 depends on the angle α between the hinge axis 6 and the straight portion 12, and is chosen so that the peg 14 can be received in slot 19 that is formed in the body part 3. The other end of the straight portion 12 is provided with a hook shaped portion 17 (FIG. 7) that includes a peg 18. The peg 18 is received in a slot 34 that is formed in the rotatable portion 21 of the actuator 20. Thus, the connecting rod 10 is operatively connected with the actuator assembly 20 at its one end and with body part 3 at its other end. The torque delivered by the actuator 20 is transmitted by the connection rod 10 to the body part 3. The angle between the pegs 14,18 and the straight portion 12 has been chosen such that the pegs 14, 18 are during most of the movement as close as possible to a 90° angle with the hinge axis 6 so that a maximum amount of torque can be transmitted from the actuator assembly 22 to body part 3.

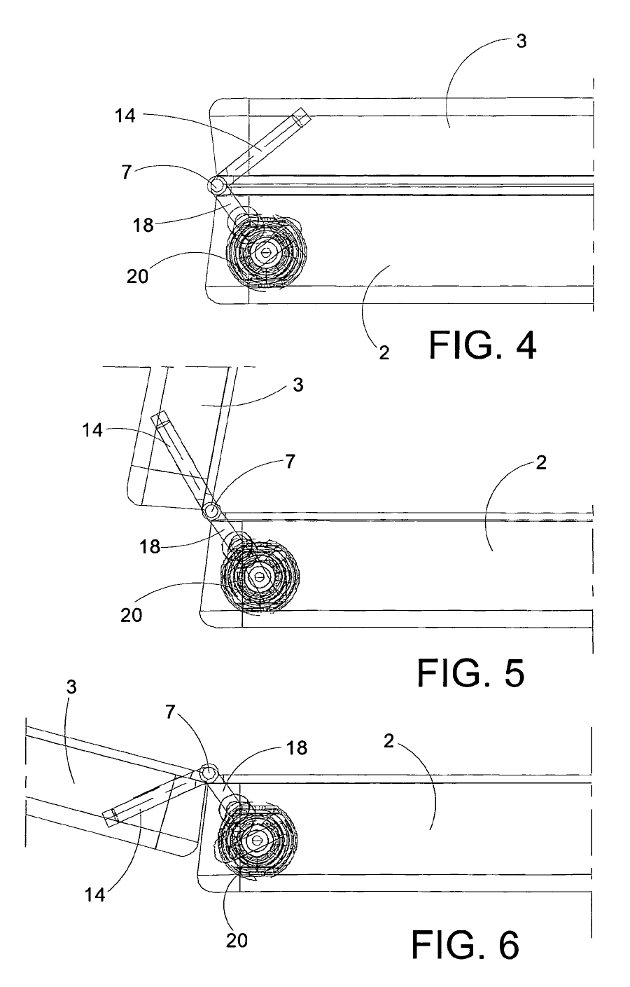

FIGS. 4,5 and 6 show the hinge construction in a detailed and partially transparent side view in the closed, intermediate and open position, respectively.

FIG. 7 shows the connecting rod on its own in detail including the straight section 12, the elbow 13 the enlarged diameter section 16, the hook like section 17, and the pegs 14,18.

FIG. 8 shows a cut open view of the actuator assembly 20, with the stationary part 22, the rotatable part 21, and the connecting rod 10 mounted at an angle α with the hinge axis 6.

According to an embodiment (not shown) the actuator assembly is disposed in one of the body parts and is connected with the other body parts by a connecting rod with a different shape than the shape shown in the embodiments above.

FIG. 9 shows another embodiment that is essentially identical with the embodiments described above, except that the actuator 20′ has moved to the second body part 3 and is operably connected with peg 14. Further, the actuator 20′ is a linear actuator, which may for example include a compression spring or other linear spring.

The embodiment with the actuator 20 in the first body part 2 and the embodiment with the actuator 20′ in the second body part 3 can be combined to obtain a foldable apparatus with an actuator in each housing part. In this combined embodiment one of the actuators could be used for the force in the closing direction and the other actuator can be used for the force in the opening direction.

Although the invention has been described with the “straight portion” 12 being straight, it is understood that this part of the connecting rod 10 can also be curved in a not shown embodiment. The same applies for peg 14 that may in an embodiment be curved.

Although the hinge construction according to the invention has been illustrated by means of a mobile phone 1, it is clear that the hinge construction according to the invention can be applied to any other apparatus with a foldable body. The body parts of the foldable construction do not need to be equal in size, dimension or weight, i.e. one of the body parts could be a main housing while the other body part is a flip or lid.

The invention has numerous advantages. Different embodiments or implementations may yield one or more of the following advantages. It should be noted that this is not an exhaustive list and there may be other advantages which are not described herein. One advantage of the invention is that it allows for a hinge construction with a reduced diameter. Another advantage of the invention is that it allows for a construction in which the actuator assembly is located in one of the body parts as opposed to being located inside the hinge. Yet another advantage of the invention is that it allows for a compact and in particular slim construction of a foldable apparatus. A further advantage of the invention is that it allows for the inside surface of the mobile apparatus that is formed by the two body parts to be almost a continuous surface with only a very thin hinge separating the two inner surfaces of the mobile apparatus. Thus, a more flush operating face is provided. Another advantage of the invention is that it provides for a hinge that is less visible in the closed and open position.

The term “comprising” as used in the claims does not exclude other elements or steps. The term “a” or “an” as used in the claims does not exclude a plurality.

Although the present invention has been described in detail for purpose of illustration, it is understood that such detail is solely for that purpose, and variations can be made therein by those skilled in the art without departing from the scope of the invention.

1. A hinge construction comprising:
a first body part;
a second body part connected to a first body part by a hinge, said hinge having a hinge axis;
a first actuator assembly and;
a link rod operably connected to said first actuator assembly, said link rod comprising a first portion and a peg, said peg being displaced at an angle with said first portion, said peg being connected to said first portion by an elbow portion, said elbow portion substantially coinciding with said hinge axis, said first portion being rotatably suspended in said first body part, and said peg being received in a slot in said second body part.

2. A hinge construction according to claim 1, wherein said first actuator assembly is disposed in said first body part and wherein said first actuator assembly is operably connected to said first portion.

3. A hinge construction according to claim 2, wherein said first actuator assembly is a rotatable actuator.

4. A hinge construction according to claim 1, wherein said first actuator assembly is disposed in said second body part and wherein said first actuator assembly is operably connected to said peg.

5. A hinge construction according to claim 4, wherein first said actuator assembly is a linear actuator.

6. A hinge construction according to claim 3, wherein one end of said first portion is connected to said first actuator assembly.

7. A hinge construction according to claim 3, wherein said first actuator assembly comprises a cam mechanism that translates a rotating movement into a linear movement.

8. A hinge construction according to claim 1, further comprising a second actuator assembly in said second body part, wherein said second actuator assembly is operably connected to said peg, wherein said first actuator assembly is disposed in said first body part and wherein said first actuator assembly is operably connected to said first portion.

9. A hinge construction according to claim 1, wherein said hinge further comprises a tubular element and a hinge pin, said hinge pin having a diameter that is substantially equal to the diameter of the elbow portion.

10. A hinge construction according to claim 9, wherein said rod having a rod diameter at said elbow portion, said tubular element having a tubular element outer diameter, and said rod diameter being substantially as long as said tubular element outer diameter.

11. A construction according to claim 1, wherein said first portion comprises a section having an increased diameter or thickness for transmitting axial forces applied to said first portion to said first body part.

12. A hinge construction according to claim 1, wherein said first portion includes a section with a reduced diameter or thickness for transmitting axial forces applied to said first portion to said first body part.

13. A hinge construction according to claim 1, wherein said rod includes a second peg at an angle to said first portion, said second peg being received in a slot formed in said first actuator assembly.

14. A hinge construction according to claim 7, wherein said first actuator assembly includes a compression spring or an extension spring.

15. A hinge construction according to claim 1, wherein said first portion is placed at an acute angle with said hinge axis.

16. A hinge construction according to claim 1, wherein said first actuator assembly is configured to define a stable closed position and a stable open position.
